(19) United States
(12) Patent Application Publication
(10) Pub. No.: US 2012/0201268 A1
(43) Pub. Date: Aug. 9, 2012

(54) Optical absorption meter

(75) Inventors: Stephen Thomas Boyd, Albuquerque, NM (US); Wolfgang G. Rudolph, Albuquerque, NM (US)

(73) Assignee: STC.UNM

(21) Appl. No.: 13/385,016

(22) Filed: Jan. 27, 2012

Related U.S. Application Data
(60) Provisional application No. 61/462,095, filed on Jan. 28, 2011.

(51) Int. Cl. G01K 17/00; G01K 7/36

(52) U.S. Cl. 374/33; 374/E17.001; 374/E07.039

(57) ABSTRACT

An optical absorption calorimeter performs absorbance measurements at low cryogenic temperatures, such as above 0K to 5K (e.g. near liquid helium temperature), using high-resolution thermometry with SQUID readout to probe optical absorption to better than 1 ppb. This improved sensitivity yields improved performance in calorimetric absorption spectroscopy by lowering the required excitation power, improving the spectral resolution, and opening up the full spectrum, from near-IR to near-UV and beyond for analysis.

This application claims benefits and priority of U.S. provisional patent applications Ser. No. 61/462,095 filed, Jan. 28, 2011, the entire disclosure of which is incorporated herein by reference.

### FIELD OF THE INVENTION

The present invention relates to optical absorption calorimetry and, more particularly, to an optical absorption meter and method based on calorimetry employing temperature sensors with SQUID read-out device operating at low cryogenic temperatures in a manner to improve the sensitivity of optical loss measurements by several orders of magnitude.

### BACKGROUND OF THE INVENTION

Many areas in science and technology require materials of the utmost purity and quality. In optics and photonics, wide-gap dielectric materials are particularly important as bulk materials for substrates, nonlinear optical elements, and optical coatings. In optical materials, operational limitations are often determined by residual absorption due to defects in the materials. In high power laser systems, a tiny absorption leads to heating and component failure. Even in lower power systems, these absorptions can be critical as they can lead to gradual accumulation of laser induced trap states. State of the art lithographic systems are another example where photo-degradation of the imaging optics eventually leads to distortion of features and costly component replacement. Issues related to material purity are also important in numerous areas of active research, including laser cooling and magnetic semiconductors to name only two prominent examples. In addition, the measurements of small absorptions in optical materials are crucial in such high profile projects such as LIGO (Laser Interferometer Gravitational Wave Observatory, NSF) and NIF (National Ignition Facility, DOE).

Indirect determination of absorption in dielectric materials by combination of reflection and transmission measurements is generally inadequate because of the precision required to extract small values. The high sensitivity of fluorescence measurements typically cannot be utilized since fluorescence is strongly quenched in many materials of interest. Today, the most sensitive absorption measurements involve the detection of small temperature changes. This can be done through calorimetry, or through photothermal effects, using a secondary optical probe.

Techniques based on the latter, such as laser-induced deflection and common-path interferometry have reached sensitivities of 0.1-1 ppm (parts per million) for selected wavelengths where lasers of a few Watts of average power are available. Similar sensitivities can be obtained with laser calorimeters and “ordinary” temperature sensors if suitable excitation lasers are available. In a variety of technical applications, the sensitivity of laser calorimetry is ultimately determined by the temperature change of a weakly absorbing sample that can be measured for a given optical excitation power. It is therefore dependent upon the resolution of the thermometer used and the heat capacity of the absorber. Platinum thermistors with 50 μK resolution enable absorbance measurements down to 0.1 to 1 ppm. However, these sensitivities may not be sufficient to characterize materials for the next generation of high power lasers (for example high power femtosecond and free electron lasers) or for components in “photon storage” devices such as interferometers.

The present invention can be used to study native and laser induced defects in optical dielectric films, which is of immense current interest for the development of the next generation of high power continuous-wave and pulsed lasers and can also be used for a broad spectrum of materials research and biomedical problems.

### SUMMARY OF THE INVENTION

The present invention provides an optical absorption calorimeter achieving breakthrough sensitivity in optical absorption by using measurement techniques only possible at low temperatures. While low temperatures have been previously used to decrease sample heat capacity in the measurement of optical absorption, the present invention is the first to use one or more high-resolution thermometers with one or more SQUID readout devices. These thermometers have demonstrated temperature noise of 0.1 nK/√Hz near 2.2K, and thus temperature resolution of better than 1 part in 10¹⁰. The use of these thermometers allows the present invention to greatly improve on the absorbance sensitivity of previous approaches. As described below, the present invention contains features which enable the use of these very sensitive thermometers as well as features to help realize their full potential for measuring extremely low levels of absorbance.

An illustrative embodiment of the invention provides an optical absorption calorimeter comprising a cryostat in which a specimen (sample) resides at a low cryogenic temperature range, one or more optical excitation sources disposed outside the cryostat, an optical fiber or windows in the cryostat for coupling one of the excitation (light) sources and a specimen in the cryostat for optically exciting the specimen at a given optical excitation wavelength, and one or more high resolution temperature sensors (e.g. paramagnetic temperature sensors) which are operably associated with the specimen inside the cryrostat and which are readable by SQUID device inside the cryostat for determining the energy absorbed by the specimen when excited. In a particular illustrative embodiment, high resolution temperature sensors are associated with the sample and its enclosure and are read by SQUID devices in the cryostat. A data acquisition device is disposed outside the cryostat for controlling the light source, receiving and processing data from the SQUID thermometer readout devices and (optionally) providing active temperature control for the thermal damping network. The temperature change of the specimen can be measured as a function of the excitation wavelength, from which a local absorption coefficient of the specimen can be determined.

The specimen can be mounted on a low temperature scanning XYZ stage inside the cryostat. The high resolution temperature sensors/SQUID devices preferably comprise a paramagnetic temperature sensor whose magnetization changes in response to temperature change of the specimen and a low-T_{C} SQUID device to sense the change in magnetization of the paramagnetic temperature sensor. A temperature resolution of 0.1 nK/rt Hz at temperatures near 3K can be achieved by practice of an embodiments of the invention to provide an improvement in energy absorption measurement of two or more orders of magnitude over what can be achieved using calorimetry near room temperature. An illustrative embodiment employs paramagnetic temperature sensors which comprise paramagnetic thermometric elements having a paramagnet in a magnetic field. The paramagnet can comprise a dilute alloy of magnetic dopants in noble metal hosts, which have achieved high temperature resolution and offer the advantages of good stability over time, insensitivity to environmental conditions, good thermal conductivity, and ease of attachment to the thermally conductive members.

By taking advantage of the extraordinary temperature resolution that can be achieved at such low temperatures, optical absorption calorimeters and methods pursuant to embodiments of the present invention can probe optical absorption down to the ppb (parts per billion) level or lower. This improved sensitivity can solve problems of current conventional devices and measurement methods. The sensitivity can allow use of lower power light sources, opening up the full spectrum for analysis, combining absorption measurements with spectral resolution to obtain loss spectra with unprecedented sensitivity, allowing calorimetric absorption spectroscopy to resolve the fine structure of electronic absorption spectra. This new capability can allow identification of the physical and chemical nature of native and laser induced defects, which is necessary to mitigate deleterious effects. Spatial resolution capabilities can make the instrument also attractive for 2D mapping of materials and biomedical imaging.

The present invention exploits the extraordinary temperature resolution that can be obtained with SQUID-readout paramagnetic thermometry at low temperatures. For best performance, the refrigerated stage should reach a temperature low enough for low-Tc SQUIDs to operate, which is approximately 5 degrees Kelvin. Performance can be further improved by cooling the sample, thermometers, and SQUIDs to temperatures lower than 5K to further decrease heat capacities and thermal noise sources. A SQUID may be thermally decoupled from its associated sample and thermometer by a superconducting flux transformer, and the sample and thermometer may be operated at a lower temperature than the SQUID. The lower limit on useful operating temperature of paramagnetic thermometers with SQUID readout is below 1 mK. The lower limit on useful operating temperature of the sample and thermometer in the present invention will probably be set by stray light heating to values above 1 mK.

Thermometer resolution is determined by the thermal contact between the sample and the thermometer. Optimal energy resolution performance generally requires matching the heat capacity of the thermometric element to the heat capacity of the sample, and minimizing all other heat capacities. Optical excitation allows chopping, synchronous demodulation, and signal averaging, which remove the otherwise absolute limits on performance set by the fluctuation-dissipation theorem.

The present invention can be embodied using any refrigeration system that can cool a refrigerated stage below 5K. This includes cryostats based on liquid cryogens and cryostats based on mechanical refrigerators. Provision of an intermediate-temperature refrigerated stage, typically 65K for a mechanical refrigerator or 77K for a liquid-nitrogen jacketed liquid-helium cryostat, is useful for heat-sinking of wires and plumbing, and for improved thermal filtering of an optical beam that enters the cryostat through windows or an optical fiber, but is not required to embody the invention.

The use of a heat switch means that mechanical refrigerators can easily be used to cool the present invention. A heat switch is provided to switchably establish a strong thermal link from the suspended sample holder to the sample enclosure which surrounds it. The heat switch can be of either the mechanical or the gas-gap variety. A mechanical heat switch will provide the highest possible thermal switching ratio and thus the best performance. Such a mechanical heat switch can be actuated by a solenoid. The action of the solenoid opens and closes a pair of jaws which can clamp on a wire that is anchored to the suspended sample holder. With the mechanical heat switch jaws in the open position, the suspended sample holder is extremely well isolated thermally. With the mechanical heat switch in the closed position the suspended sample holder is strongly linked thermally to the sample enclosure. The provision of a heat switch obviates the need for helium exchange gas for cooling the sample that is required in some earlier calorimeters, such as that of U.S. Pat. No. 4,429,999. The elimination of the requirement for helium exchange gas makes the embodiment of the present invention in a mechanically-cooled cryostat simple, since no hermetic volumes with demountable seals need to be created inside the vacuum shell. This will result in embodiments that are simpler to use and do not require low-temperature physics experts to operate. These embodiments are thus much more suitable for the commercial market. The elimination of helium exchange gas also removes a significant source of adsorbed gas on the cooled sample, and makes possible a sample surface cleaning procedure to remove adsorbed gas layers extremely effectively, as described below.

For maximum versatility and sensitivity in absorbance measurements, the present invention will preferably be embodied with a windowed cryostat. Windows are compatible with all envisioned excitation schemes, including beams with high power and the use of short pulses. However, the increased absorbance sensitivity of the present invention means that in some cases adequate absorbance sensitivity may be obtained with the more limited range of excitations that can easily be provided via fiber optic cable. Embodiments of the present invention that use fiber optic for excitation delivery allow the elimination of windows in the cryostat, considerably simplifying the cryostat design, fabrication, and operating procedures, and are thus well-suited for commercial deployment. Embodiments with fiber optic also improve control over stray light heating because the use of fiber optic allows the greatest possible control over the beam; for example, by eliminating scattering from surface contamination or defects on windows.

The excitation beam may thus enter the cryostat via windows or via optical fiber. In both embodiments, provision can be made for thermal filtering of the beam to remove room-temperature black-body radiation before the beam impinges on the sample. After passing through the sample the beam, which is only slightly attenuated, may exit the cryostat via windows or fiber, or be absorbed within the cryostat in a beam dump anchored at a temperature between the refrigeration stage temperature and room temperature. Mirrors, windows, lenses, and other optical components can be used inside the cryostat to route the beam, bring the beam to a focus, or otherwise alter beam properties. A focused beam can be used to obtain high spatial resolution in absorbance images created using the XYZ scanner. A focused beam and XYZ scanner can also obtain 3D absorbance images via nonlinear absorption that can occur at the focus with short pulse excitation. The power of the beam can be measured before or after it traverses the sample, to improve the accuracy of the derived absorbance.

At the improved temperature resolutions achievable with the SQUID-readout paramagnetic thermometers, small temperature variations created by different cooling techniques can become comparable to or larger than the signal that is to be measured. These temperature variations can be periodic, as occurs with mechanical cryogenic refrigerators, or they can be aperiodic temperature noise, as occurs on the microKelvin level when pumping on liquid cryogens, or some combination of both. For the present invention means can be provided to reduce these temperature variations to a level permitting measurements to be made. This reduction of temperature variation is accomplished by using a thermal damping network of heat capacities and thermal resistances as the thermal connection between the sample enclosure and the refrigerated stage. This thermal network can be optimized using standard heat flow analysis techniques to act as a low-pass filter so that the temperature variations at the sample enclosure can be reduced to the required levels. The refrigerated stage, sample enclosure, and the suspended sample holder are all included in this thermal network analysis, as well as one or more additional nodes that may be interposed between the refrigerated stage and the sample enclosure to achieve optimal temperature noise damping and temperature stabilization.

The thermal network performance can be improved by the use of active temperature control, by attaching thermometers and heaters to one or more nodes of the thermal damping network. Established computational algorithms can accept readings from the thermometers and command excitation to the heaters to improve thermal damping and establish temperature control.

Active control of the thermal network also enables a new measurement mode that can reduce the effective sample time constant. Active control of the thermal network allows optical absorption measurements to be performed with the temperature of the suspended sample holder under active control. In this measurement procedure the reduction in the heater power required to maintain the temperature of the sample that results when excitation is applied to the sample is equal to the power absorbed by the sample. This approach offers the advantage that the effective thermal relaxation time can be greatly, and controllably, reduced, increasing measurement flexibility without hardware changes.

The discussion of the temperature noise background against which the absorbance measurement must be made leads to consideration of how many of the high-resolution thermometers should used in practice of the invention, and how they should be disposed. One must be used on the suspended sample holder, but it can also be useful to have one or more additional high-resolution thermometers.

The beam power which is absorbed by the sample during excitation warms the sample. The resulting increase in the temperature of the suspended sample holder causes the absorbed power to flow out from the suspended sample holder to the sample enclosure via the thermally-isolating suspension. The present invention carefully eliminates all other heat flow paths. The instantaneous outflow of power P from the suspended sample holder to the sample enclosure may be deduced as P=(Tₛₐₘₚₗₑ−T_{enclosure})/Rₛᵤₛₚₑₙₛᵢₒₙ, where Tₛₐₘₚₗₑ is the measured temperature of the suspended sample holder, T_{enclosure} is the measured temperature of the sample enclosure, and Rₛᵤₛₚₑₙₛᵢₒₙ is the thermal resistance of the suspension. We see that the temperature of the sample and the temperature of its enclosure have equal weight in this formula. If there were no temperature noise on the enclosure then knowledge of the change in Tₛₐₘₚₗₑ resulting from excitation would suffice for the absorbance measurement. However, since T_{enclosure} varies with time due to noise, for best precision in the measurement of absorbed power, it is desirable that the temperature of the sample enclosure also be measured with a high-resolution thermometer with SQUID readout device.

When active control is used in the thermal damping network, it may also be desirable to equip or more of the nodes of the thermal damping network that are nearest to the sample enclosure with high-resolution thermometers. The goal of the thermal damping network is to bring the temperature noise of the sample enclosure down to a level which is “quiet” on the scale of the high-resolution thermometer. It may be the case that, for the sample enclosure temperature to be adequately “quiet,” given the demands of a particular embodiment, the temperature of the node nearest to the sample enclosure must already be too “quiet” to be adequately measured and controlled with a commercial resistive thermometer. As a result, the invention envisions providing a high resolution thermometer on one or more nodes of the thermal damping network nearest or proximate the sample enclosure.

Similar to the need for control of thermal noise, in order for the SQUIDs and paramagnetic thermometers to work well, they must also be protected from environmental magnetic noise. To this end a high-permeability magnetic shield surrounds the cryostat and the sample enclosure is surrounded by a superconducting shield.

At the very low absorbance levels measurable with the present invention, the impact on measurement accuracy caused by unintended absorption of excitation electromagnetic radiation by components of the suspended sample holder other than the sample itself (“stray light heating”) becomes increasingly important. Several features can be implemented in the sample enclosure to provide the best possible control of this problem.

To reduce stray light heating, the sample enclosure can be partitioned into two chambers, the excitation chamber and the thermometer chamber. The excitation electromagnetic energy is applied to the sample in the excitation chamber. Measurement of the resulting temperature change is performed in the thermometry chamber. The sample and thermometer are both attached to, and thermally connected by, the suspended sample holder, which passes through an opening between the excitation and thermometry chambers. A system of baffles can prevent any stray light from passing from the excitation chamber to the thermometer chamber. The division of the sample enclosure into two light-tight chambers provides the best possible control of stray light heating. The sample-holder components that extend into the excitation chamber can be kept to simple, small geometries that minimize surface area and make it easy to keep those reflective surfaces very clean to minimize stray light heating. To further reduce stray light heating, all surfaces of the suspended sample holder that may be exposed to stray light should be highly reflective at the wavelengths of interest and kept clean of surface contamination. To minimize stray light which may reflect towards the suspended sample holder from the interior walls of the excitation chamber, all interior surfaces of the sample enclosure, including the excitation and thermometer chambers and the components of the baffling comprised by interior surfaces of the sample enclosure, should be coated to produce a surface that is highly absorbing at the wavelengths of interest. The interior of the stage 2 shield should also be coated in this way.

The system of baffles can be disposed so that it creates no mechanical contact (and thus no additional thermal contact) between the suspended sample holder and the sample enclosure. The system of baffles can simultaneously be disposed so that it permits the sample to be moved relative to the intensity distribution of the excitation electromagnetic energy (“scanning the sample”). The part of the baffling that is part of the suspended sample holder should be highly reflective at the wavelengths of interest and kept free of surface contamination.

The improved absorbance sensitivity of the present invention allows accurate measurement of ultra-low absorbance samples. Achieving truly clean surfaces on the sample is vital for this type of measurement to avoid spurious surface absorption processes. A cryogenic measurement at 5K and below, such as the present invention, introduces the problem that all residual gas in the cryostat vacuum space will adsorb onto the cold surfaces of the sample. The thickness of these adsorbed gas layers can be reduced by following good vacuum practice and ensuring that the cryostat is pumped down to a good vacuum before cooling down the cryostat. A mechanical heat switch is provided to eliminate the need for exchange gas to cool the sample, which essentially eliminates adsorbed helium from the problem. However, these precautions will not usually be sufficient to ensure that the surfaces of the sample are completely clean.

The use of a mechanical heat switch in the present invention enables a sample surface cleaning procedure that can be followed once the sample enclosure has reached a low temperature. The suspension of the sample provides a high level of thermal isolation for the sample holder when the jaws of the mechanical heat switch are open. The provided heater on the sample holder can be used to raise the temperature of the sample for a period of time, expelling the adsorbed gases, which then re-sorb onto the nearby cold interior surfaces of the sample enclosure. Some gases, such as H₂, ⁴He, and ³He, that have high vapor pressures at low temperatures, will not be well-trapped onto those interior surfaces. To ensure that those gases are trapped effectively a sorption pump made of sorbent such as charcoal is provided by attaching a thin layer of the sorbent to part of the bottom inside surface of the excitation chamber with adhesive. This type of sorption pump has extremely high pumping speed, and is in close proximity to the sample, ensuring that all gas molecules expelled from the sample surface are securely trapped. Once the sample surface cleaning procedure is complete, the heat source is turned off and the jaws of the mechanical heat switch are again closed to re-cool the sample in preparation for measurement.

In the present invention the mechanical attachment of the sample holder to the XYZ scanner is via a tensioned fiber suspension or other suspension providing a very high degree of thermal isolation. Similarly, the electrical wiring connections to the suspended sample holder use thin resistance wire or superconducting wire with very high thermal isolation. Thus the baseline thermal resistance between the suspended sample holder and the sample enclosure is very high. This makes it easy to tune the thermal resistance to any lower value by simply attaching an appropriate thermally conductive member to both the suspended sample holder and the sample enclosure. This thermally conductive member can often just be a wire.

The ease with which the thermal resistance can be tuned allows the thermal relaxation time of the suspended sample holder to be easily tuned. This allows optimal tuning for steady-state or pulsed measurements, and for samples with a wide range of heat capacities.

The sample may be any solid element or material whose optical absorbance is to be investigated. The sample is mounted on a low-temperature scanning stage in the cryostat. The present invention can be embodied with a variety of different scanning stages, or no scanning stage at all, depending on the details of the measurements to be performed. At present, a number of suitable low-temperature scanning stages with linear or rotary motion, different ranges of travel, and different positioning accuracy can be assembled from commercial components available from Attocube Systems AG. However, other vendors have recently begun to produce cryogenic scanning stages as well and the use of Attocube components is not required.

Linear motion (X or XY) can be used to create a “map” of absorbance over a sample (e.g. absorbance microscopy), or to move the specimen into and out of the optical path for a “chopped” measurement (perhaps to determine the impact of stray light), or to choose between multiple specimens, perhaps including a reference absorbance specimen, in the optical path, or to choose between specimens of identical materials but different thicknesses to differentiate between bulk and surface effects. Linear motion (Z) is envisioned as useful for bringing the surface of the specimen under study to the focal point created by an optional lens (microscope objective) placed in the optical path, to achieve the best possible spatial resolution. Linear motion (Z) with a focused beam can also achieve 3D resolution of absorbance within the bulk of the sample by use of short excitation pulses to excite nonlinear absorption processes, which only occur in the focus. Rotary motion (Θ) of the specimen(s) can be used to vary the optical path length in the specimen, to study angle-dependent reflection, transmission, and absorption, or stray light effects. In addition, all of these scanning configurations can be combined with polarized excitation light, pump-probe geometry, or other optical configurations. Further, the scanning stage can be used to manipulate the optical path in addition to, or instead of, moving the specimen. The present invention can be usefully embodied with any or all of the scanning and optical path configurations just described, but is not so limited.

Other advantages of the present invention will become more apparent from the following detailed description of the invention taken with the following drawings.

### BRIEF DESCRIPTION OF THE DRAWINGS

FIG. 1 is a schematic longitudinal sectional view of the invention, including optical excitation source and sink and the cryostat.

FIG. 2 is a detailed longitudinal sectional view of the sample enclosure, which houses the sample and the SQUID-readout paramagnetic thermometers, with front portion of the cat's cradle suspension not shown because of sectioning but appearing in FIGS. 4a, 4b, 4c.

FIG. 3 is a simplified enlargement of a portion of FIG. 1 showing the electrical resistance thermometers and resistance heaters attached to each node of the thermal damping network, and the thermal links (e.g. wire, strip, or bar of brass, copper or other material) attached between the nodes.

FIG. 4a, 4b, 4c are elevation, plan and perspective views showing the tensioned fiber suspension (“cat's cradle”) for mechanically supporting the specimen holder while maintaining a very high thermal isolation.

### DETAILED DESCRIPTION OF THE INVENTION

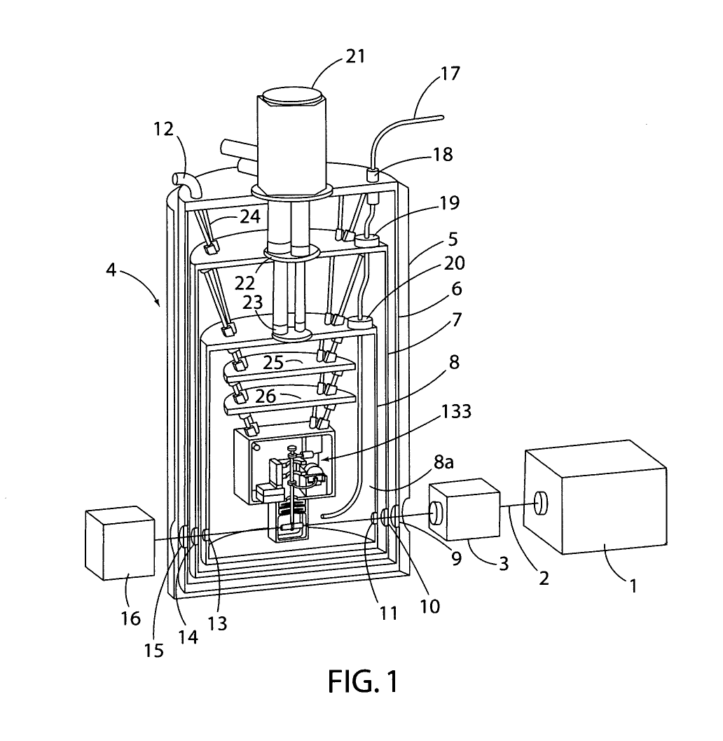

FIG. 1. shows the preferred embodiment of the present invention using a commercial mechanical refrigerator 21 as a source of refrigeration and windows as the principal means for the entry and exit of the beam of electromagnetic energy. No additional refrigeration stages are included in this simple cryostat, so the minimum temperature in the system is simply what the mechanical refrigerator can provide. The mechanical refrigerator 21 shown is a Cryomech PT-405, which is attached to a compressor (not shown) via two flexible metal hoses (also not shown). This refrigerator can achieve a base temperature below 3K.

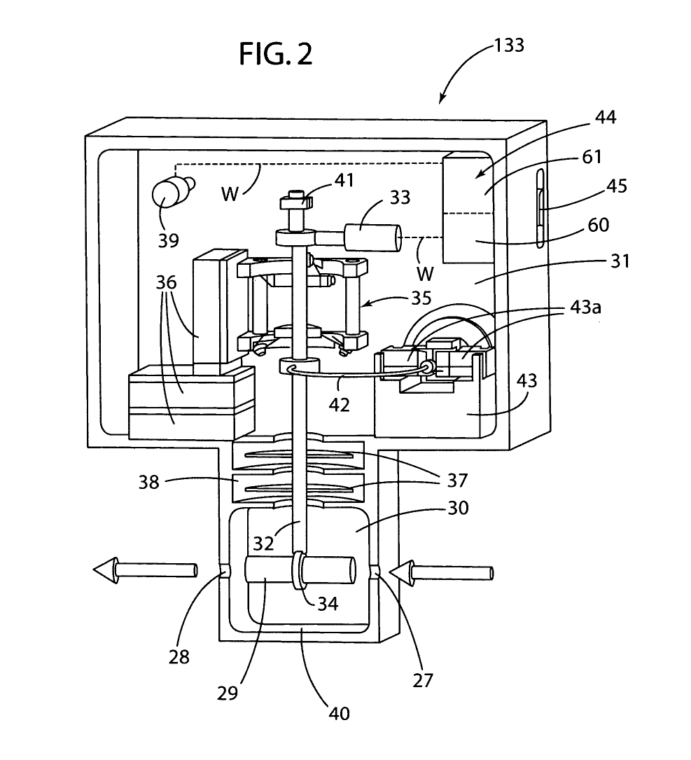

The optical path is first described, referring to FIG. 1. Optical excitation sources include commercially available spectral lamp, pulsed or cw (continuous wave) laser, and white light laser. The excitation source 1 creates the excitation beam 2 of electromagnetic energy which passes through any required optical processing such as a monochromator 3 before entering the cryostat 4. The beam enters the cryostat by passing first through a hole in the magnetic shielding 5, then through optical windows 9, 10, and 11, which are attached, respectively, to the vacuum shell 6, the stage 1 radiation shield 7 (nominal operating temperature 65K), and the stage 2 radiation shield 8 (nominal operating temperature 3K). The beam next passes through the sample enclosure 13, which is shown in FIG. 2. and will be described below. The beam then exits the cryostat via windows 13, 14, and 15, which are mirror symmetric to 9, 10, and 11 and finally passing out through a second hole in the magnetic shielding 5. The windows can be fused silica (e.g. NT 84-458 fused silica windows from Edmunds's Optics) or other material depending on the wavelength range of interest. The beam terminates in a power meter 16, the reading from which is used in the absorbance calculation.

Window 9 and its counterpart 15 are both sealed hermetically to the vacuum shell 6 so that the cryostat 4 may be evacuated by a vacuum pump (not shown) connected to the internal space of the cryostat through tubulation 12, before cooling down the system.

An alternative entry of the excitation beam to the cryostat can be accomplished via a fiber optic cable 17 which enters the cryostat through a hermetic feedthrough 18. The cryostat shown is furnished with both windows and fiber optic, but in this embodiment both optical paths cannot be used at the same time. When the excitation beam enters via the windows, as shown in FIG. 1, the lower end of the fiber optic cable is disconnected from the sample enclosure 133 and tied off so that it is out of the way of the beam. If it is desired to use the fiber optic, the room-temperature end is attached to an excitation source and the cold end is attached to the sample enclosure 133. The windows can be blocked when using the optical fiber to achieve best stray light performance.

For both the windows and the fiber optic, the incoming beam can be thermally filtered by passing through cooled windows to remove the thermal black-body infrared radiation, which otherwise constitutes an uncontrolled addition to the excitation of the sample. When the excitation beam is brought in through the windows, this filtering occurs at windows 10 and 11 which are cooled by their respective radiation shields to 65K and 3K. When the excitation beam is brought in via fiber optic, this filtering occurs at the fiber thermal intercepts 19 and 20.

The cryostat is now described, again referring to FIG. 1. The mechanical refrigerator 21 as a source of regfrigeration has stage 1 and stage 2 heat exchangers 22 and 23 which are attached to the stage 1 and stage 2 radiation shields 7 and 8. The radiation shields and other components inside the vacuum shell are mechanically supported by arrays of thermally-insulating legs, such as 24. The interior surface 8 is coated with superconductor, such as lead which can be flowed onto the copper or brass radiation shield with a hand torch or other materials, for magnetic shielding, and that superconductor is then coated to make it highly absorbing at the excitation wavelengths of interest.

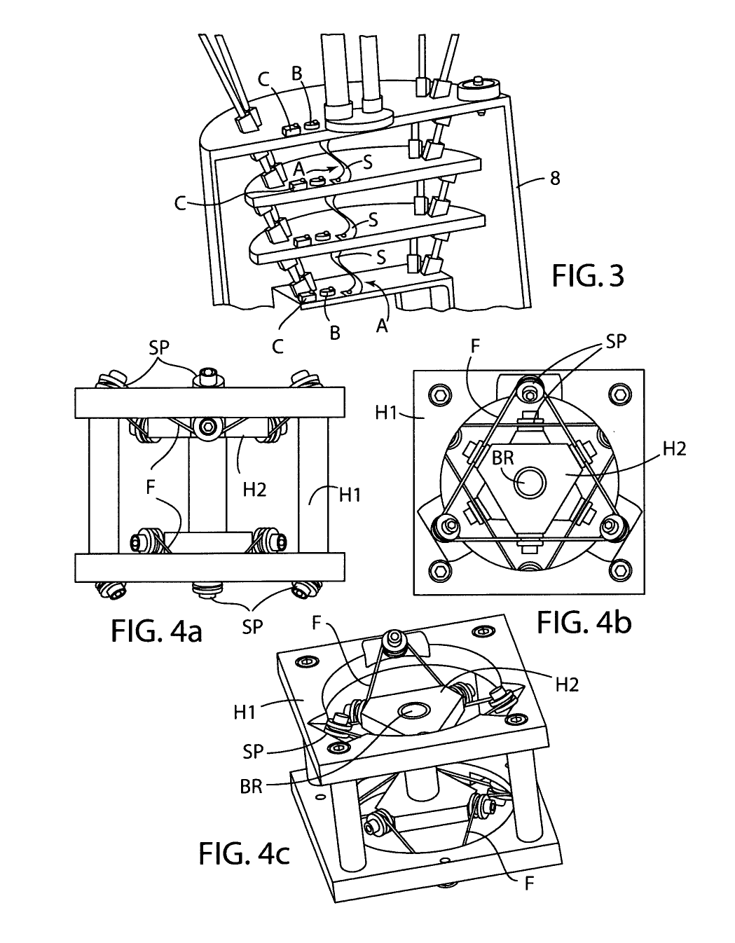

The thermal damping network nodes are the stage 2 radiation shield 8, the two stages depending from it 25 and 26, and the sample enclosure 133. Each node is configured with thermal links A to the nodes above and below it: 8 is connected to 25, 25 is connected to 8 and 26, 26 is connected to 25 and 133, and 133 is connected to 26. Each node is also configured with a commercial resistance thermometer B and an electrical resistance heater C, FIG. 3. The heat capacities of the nodes and the strength of the links between them are chosen using established thermal modeling techniques to provide maximal damping of temperature noise in the absence of active control. The thermometers and electrical heaters on each node allow active control to be established if desired to further improve thermal damping and allow temperature control. The purpose of the thermal damping network is to minimize temperature noise at the sample enclosure 133.

Referring to FIG. 3, the thermal links comprise a strip S (or a wire, bar or other connection) of brass or copper with its ends attached to two adjacent nodes. Although the thermal links all are shown the same in FIG. 3, in reality the material and geometry of the thermal links are chosen to achieve the desired thermal conductance between the two nodes. Resistive thermometers and readout are commercially available with an exemplary resistive thermometer being RX-202A-CD and readout 370AC resistance bridge available from LakeShore Cryotronics for purposes of illustration and not limitation.

The contents of the sample enclosure 133 are shown in more detail in FIG. 2. The optical path is indicated with the arrows, entering via hole 27, passing through the sample 29 and exiting via hole 28. The sample enclosure 133 is divided into two chambers, the excitation chamber 30 and the thermometry chamber 31. A rod 32 of thermally conductive material, such as copper, silver, or sapphire, spans the two chambers, being attached to the specimen by a clamp ring 34 at the lower end, and attached to the paramagnetic thermometric element 33 at the upper end. The rod is mechanically supported only by a tensioned fiber “cat's cradle” suspension 35 which provides an extremely high level of thermal isolation between the sample enclosure 133 and the sample. The cradle suspension 35 is shown in FIGS. 4a, 4b, 4c and comprises an outer housing H1 that is mechanically attached to the three stages of the XYZ scanner 36, FIG. 2, which is attached to the enclosure 133. The cradle suspension includes an inner housing H2 having a central bore BR in which the upper end of rod 32 is fixedly received. The inner housing H2 is suspended from the outer housing H1 by strong fibers F, such as Kevlar fiber or other fiber, wrapped on spindles SP disposed on the upper and lower sides of the outer housing and inner housing as shown in FIGS. 4a, 4b, 4c.

Stray light is prevented from passing from the excitation chamber 30 to the thermometry chamber 31 by an arrangement of baffles 37 attached to the suspended rod. These baffles occupy wells 38 in the sample enclosure 133. The surfaces of the rod 32, ring clamp 34, and baffles 37 are highly reflective at the wavelengths of interest, and the interior surfaces of the excitation chamber 30, baffle wells 38, and much of the interior surface of the thermometry chamber 31 are coated to make them highly-absorbing at the wavelengths of interest. The arrangement of baffles and wells ensures that any stray light trying to pass from the excitation chamber to the thermometry chamber will experience multiple reflections against the highly-absorbing coating and be strongly attenuated before it can fall on the paramagnetic thermometric elements 33 and 39. The bottom surface of the excitation chamber 40 is partially covered by sorbent charcoal attached with adhesive to form a powerful sorption pump at low temperatures that is immediately adjacent to the sample.

An electrical heater 41 is attached to the rod, and a flexible conductive link 42 connects from the rod 32 to the jaws 43a of a solenoid-actuated mechanical heat switch 43 to provide a switchable high-conductance thermal link between the suspended rod and the enclosure.

The SQUID readout devices 60, 61 for high resolution paramagnetic thermometers (e.g. paramagnetic thermometric elements) 33 and 39 are housed in a small electronics enclosure 44 made of superconductor for magnetic shielding and schematically shown. Each SQUID reads out one paramagnetic thermometric element 33 or 39, which sense temperature of the specimen 29 and the sample enclosure 133, respectively. The element 39 is shown in FIG. 2 placed on the wall of the sample enclosure 133 but it can located anywhere in the thermometry chamber 31 for example. The electronics enclosure 44 mounts to the inside wall of the thermometry chamber to provide a light-tight connected interface. Commercially available SQUID readouts can be used such as available as SQ 1200 SQUID in the LS2076 package from STAR Cryoelectronics. Each SQUID is connected to the associated paramagnetic temperature sensor by a short length of twisted pair superconductor wire shown as dashed lines W, or by a superconducting flux transformer. The paramagnetic thermometric elements 33 and 39 each comprises a paramagnet in a magnetizing field. The paramagnet can comprise a dilute alloy of magnetic dopants in noble metal hosts, which have achieved high temperature resolution and offer the advantages of good stability over time, insensitivity to environmental conditions, good thermal conductivity, and ease of attachment to the thermally conductive members. In this class of materials, the dilute alloys of Mn and Pd have demonstrated temperature noise of 100 pK/rt Hz for temperatures and geometries similar to those encountered in practice of the present invention and thus are preferred paramagnetic thermometers 33, 39 for practice of embodiments for purposes of illustration and not limitation. A particular Mn-Pd alloy comprises 0.68 atomic % Mn and balance Pd. However, the dilute alloys of Er and Au may offer performance advantages for embodiments requiring lower sensor heat capacity. Paramagnetic thermometry is described by D A Sergatskov, P K Day, A V Babkin, R C Nelson, T D McCarson, S T P Boyd, and R V Duncan, in “New paramagnetic susceptibility thermometers for fundamental physics measurement”, AIP Conference Proceedings, 684, p. 1009-1014 (2003), the disclosure of which is incorporated herein by reference.

The measurement method pursuant to an embodiment of the invention is now described. After the sample 29 has been installed the cryostat is sealed, evacuated, and cooled down to 5K or below with the heat switch 43 jaws open. The high degree of thermal isolation provided by the tensioned fiber suspension 35 ensures that the suspended sample holder will cool very slowly, so it will still be near room temperature when the sorb pump and other surfaces around the sample are already cold. This is an “automatic” instance of the heating procedure to remove adsorbed gases from the sample described previously, and it can be taken advantage of during the cooldown. The pumping speed of the cold surfaces will be high so the jaws of the heat switch 43 can be closed soon after the sample enclosure 133 reaches 5K or below.

Once the sample has cooled to the temperature of its enclosure, the jaws of the heat switch are opened. Absolute power calibration is obtained by comparing the temperature response to known power inputs delivered by the electrical heater 41, as described in U.S. Pat. Nos. 4,185,497 and 4,429,999, which are incorporated herein to this end. Absorbance is then determined from excitation beam power and duration and the temperature response to it, as also described in U.S. Pat. Nos. 4,185,497 and 4,429,999, which are incorporated herein to this end as well.

Pursuant to various illustrative embodiments of the invention, the optical absorption calorimeter using high resolution thermometers as described above can probe absorption to better than 1 ppb (parts per billion). This improved sensitivity can increase the capabilities of calorimetric absorption spectroscopy by lowering the required beam power, enhancing resolution and opening up the full spectrum for analysis from the near IR to the near UV and beyond, allowing the fine structure of electronic absorption spectra to become resolvable for example. This higher sensitivity can allow identification of the physical and chemical nature of native and laser induced defects, which is necessary to mitigate deleterious effects. Spatial resolution capabilities can make the instrument also attractive for biomedical imaging.

Practice of embodiments of the invention can be useful and open to a variety of technical applications. For example, practice of the invention can be implemented for fundamental understanding of optical coatings and novel strategies for power scaling of high power free electron lasers and development, modeling, and testing of optical coatings with novel thermal and stress management for high energy laser applications. The instrument (optical absorption calorimeter) can be used to measure the absorption in optical films by intrinsic and photoinduced defects. Because of the quality of these films and their thickness, these absorption values of interest are in the range of 10 ppb-10 ppm. The ability to select the excitation wavelength can allow the identification of the states in the band gap of the materials. These states are known to lead to failure of optical components in UV systems as well as in high power laser systems at all wavelengths. At the moment, using conventional techniques; the presence of such absorption centers can only be measured (guessed) indirectly in optical coatings. A method of detecting them directly may be crucial for further improvements to optical technologies.

Practice of embodiments of the invention further can be used with respect to laser cooling of solids. Materials of extremely low absorption in certain spectral bands are needed to extract anti-Stokes fluorescence from the sample without residual absorption leading to heating. Other embodiments of the invention envision performance of optical pump-probe measurements in general at low (liquid Helium) temperatures. This is important in a variety of materials research problems. Additionally, it can be used for biological samples, to measure weak absorption contrasts in cells at specific wavelength with spatial resolution, providing this capability at sensitivity levels that are several orders of magnitude better than what is possible with current microscopes.

The present invention envisions modifications of the calorimeter and calorimetry method described above with respect to optical design, testing, and calibration can be conducted to optimize the system's performance. Modifications may be implemented to address issues like optical beam delivery, suppression of light scattering, spatial resolution through scanning, and sensor design to maximize signal-to-noise ratio. Such modifications can include SQUID and cryostat assembly as well as integration of the optical excitation sources and overall testing.

Although specific embodiments have been illustrated and described herein, it will be appreciated by those of ordinary skill in the art that any arrangement that is calculated to achieve the same purpose may be substituted for the specific embodiments shown. Upon studying the disclosure, it will be apparent to those skilled in the art that various modifications and variations can be made in the devices and methods of various embodiments of the invention. Other embodiments will be apparent to those skilled in the art from consideration of the specification and practice of the embodiments disclosed herein. It is intended that the specification and examples be considered as examples only. The various embodiments are not necessarily mutually exclusive, as some embodiments can be combined with one or more other embodiments to form new embodiments.

We claim:

1. An optical absorption calorimeter, comprising a cryostat in which a sample resides at a low cryogenic temperature range, one or more optical excitation sources disposed outside the cryostat, a window and/or optical fiber for coupling the one or more excitation sources and a sample in the cryostat for exciting the sample at a given optical excitation wavelength, and a high-resolution temperature sensor which is operably associated with the sample inside the cryostat and which is readable by a SQUID readout device inside the cryostat for determining the temperature changes of the sample when the sample is excited.

2. The calorimeter of claim 1 wherein the high resolution temperature sensor is a paramagnetic temperature sensor.

3. The calorimeter of claim 1 wherein another high-resolution temperature sensor is operably associated with a sample enclosure and is readable by another SQUID readout device inside the cryostat.

4. The apparatus of claim 2 further including a thermal damping network interposed between a source of refrigeration and a sample enclosure wherein still another high resolution temperature sensor is disposed on one or more nodes of the thermal damping network proximate the sample enclosure.

5. The apparatus of claim 3 where the paramagnetic temperature sensors are each comprised of a paramagnetic thermometric element, which is magnetically coupled, either directly or via a superconducting flux transformer, with a respective SQUID device.

6. The apparatus of claim 1 wherein the SQUID device comprises a low-T_{C} SQUID readout device.

7. The apparatus of claim 1 further including a thermal damping network interposed between a source of refrigeration and the sample enclosure.

8. The apparatus of claim 7 where the thermal damping network is actively controlled by an electronic control device disposed outside the cryostat that reads the temperatures of thermometers attached to the nodes of the thermal damping network and controls the power dissipated by electrical resistance heaters attached to the nodes.

9. The apparatus of claim 1 further including a data acquisition device disposed outside the cryostat for control of the excitation sources and receiving and processing data from the high-resolution thermometers.

10. The apparatus of claim 1 wherein the one or more optical excitation sources comprises a spectral lamp, pulsed or cw laser, and a white light source.

11. The apparatus of claim 1 including a low temperature scanning X-Y(-Z) stage inside the cryostat and on which the specimen resides.

12. The apparatus of claim 1 wherein the cryostat includes a pulse-tube refrigerator for cooling the specimen in the range of greater than 0K to about 5K.

13. The apparatus of claim 1 having a thermometry chamber and an excitation chamber in which the specimen is suspended.

14. The apparatus of claim 13 including a thermally conductive specimen holder between the excitation chamber and the thermometry chamber, the specimen holder being thermally isolated from an enclosure of the thermometry chamber by a thermal isolating suspension.

15. The apparatus of claim 14 wherein the thermal isolating suspension comprises a cat's cradle suspension.

16. The apparatus of claim 14 including a heat switch that when closed, thermally connects the specimen holder and specimen thereon and the enclosure of the thermometry chamber, and when open, thermally isolates the specimen holder and specimen thereon from the enclosure of the thermometry chamber.

17. The apparatus of claim 13 including stray light baffles between the excitation chamber and the thermometry chamber.

18. A method of measuring optical absorption of a sample, comprising cooling the sample to a low cryogenic temperature in the range of greater than 0K to about 5K in an enclosure, exciting the sample at a given optical excitation wavelength, and sensing the temperature change of the sample when the specimen is excited using a high-resolution thermometer read out by SQUID device at the low cryogenic temperature.

19. The method of claim 18 where the high-resolution thermometer is comprised of a paramagnetic thermometric element, which is magnetically coupled, either directly or via a superconducting flux transformer, with the SQUID device.

20. The method of claim 18 wherein the SQUID device comprises a low-T_{C} SQUID readout device.

21. The method of claim 18 including analyzing data from the SQUID device to determine local optical absorption.

22. The method of claim 18 wherein the sample is an optical material.

23. The method of claim 18 wherein the optical material is an optical element.

24. The method of claim 18 wherein the optical element is an optical coating or optical film.

25. The method of claim 18 including actively controlling temperature of a sample enclosure.

26. The method of claim 25 including actively controlling temperature of one or more nodes of a thermal damping network interposed between a source of refrigeration and the sample enclosure.

27. The method of claim 26 including also actively controlling temperature of a suspended sample holder.

28. The method of claim 27 including deducing absorbed power in part from the changes in one or more of the controlling powers required to maintain one or more of the actively controlled temperatures.
